(19) United States
(12) Patent Application Publication
(10) Pub. No.: US 2025/0027915 A1
(43) Pub. Date: Jan. 23, 2025

(54) DETECTION DEVICE, DETECTION METHOD, DETECTION PROGRAM, AND DETECTION SYSTEM

(71) Applicant: SHIMADZU CORPORATION, Kyoto (JP)

(72) Inventors: Hiroaki KOZAWA, Kyoto (JP); Shinji KANAZAWA, Kyoto (JP); Tomohiro KAWASE, Kyoto (JP); Yuki WATANABE, Kyoto (JP)

(73) Assignee: SHIMADZU CORPORATION, Kyoto (JP)

(21) Appl. No.: 18/764,681

(22) Filed: Jul. 5, 2024

(30) Foreign Application Priority Data
Jul. 18, 2023 (JP) 2023-116892

(51) Int. Cl. G01N 30/86; G01N 30/02

(52) U.S. Cl. CPC G01N 30/8631; G01N 2030/027

(57) ABSTRACT

A detection device includes an acquisition unit that acquires a plurality of pieces of detection data corresponding, on a one-to-one basis, to a plurality of samples, and a computing unit that processes the plurality of pieces of detection data. The computing unit acquires an identification result indicating that peak information regarding signal intensity extracted from each of the plurality of pieces of detection data is identified as peak information regarding signal intensity corresponding to a target component, and detects, in a case where there is outlier peak information among a plurality of pieces of the peak information identified for respective ones of the plurality of pieces of detection data, that an identification result corresponding to the outlier peak information is anomalous.

### CROSS REFERENCE TO RELATED APPLICATIONS

This nonprovisional application is based on Japanese Patent Application No. 2023-116892 filed on Jul. 18, 2023, with the Japan Patent Office, the entire contents of which are hereby incorporated by reference.

### BACKGROUND OF THE INVENTION

### Field of the Invention

The present disclosure relates to a detection device, a detection method, a detection program, and a detection system.

### Description of the Background Art

As disclosed in Japanese Patent Laying-Open No. 2023-012485, a technique called chromatography to separate components contained in a sample to be analyzed using a chromatograph is known. Chromatography is applied to analysis in the field of metabolomics for comprehensively analyzing specific molecules produced by cellular activities, pesticide residue analysis, and the like. The chromatograph disclosed in Japanese Patent Laying-Open No. 2023-012485 automatically identifies a target component by detecting a peak of signal intensity in a chromatogram using a peak detection algorithm.

### SUMMARY OF THE INVENTION

Samples to be analyzed by the chromatograph may contain contaminants, or even samples produced under the same conditions may contain different types of components and be different in concentration of each component from each other. In the chromatograph disclosed in Japanese Patent Laying-Open No. 2023-012485, the impact of mixing of contaminants, component variability, or the like is not particularly taken into consideration, so that there is a possibility that correct identification of the target component fails. For example, there is a possibility that a wrong peak is identified as the peak of the target component, or a part of a peak shape is identified as a wrong shape.

A method for determining whether or not a desired peak is correctly identified as the peak of the target component on the basis of the behavior of the peak detection algorithm requires a user to make a visual identification. In analysis in the field of metabolomics and pesticide residue analysis, the number of samples and the number of target components may be in the hundreds. It is cumbersome to check whether or not each of hundreds of target components contained in hundreds of samples is correctly identified by means of visual identification by the user.

The present disclosure has been made to solve the above-described problems, and it is therefore an object of the present disclosure to correctly identify a peak in a chromatogram as a peak of a target component.

A detection device according to one aspect of the present disclosure includes an acquisition unit that acquires a plurality of pieces of detection data detected by a chromatograph, the plurality of pieces of detection data corresponding, on a one-to-one basis, to a plurality of samples, and a computing unit that processes the plurality of pieces of detection data acquired by the acquisition unit. The computing unit acquires an identification result indicating that peak information regarding signal intensity extracted from each of the plurality of pieces of detection data is identified as peak information regarding signal intensity corresponding to a target component, and detects, in a case where there is outlier peak information among a plurality of pieces of the peak information identified for respective ones of the plurality of pieces of detection data, that an identification result corresponding to the outlier peak information is anomalous.

A detection method for causing a computer to detect an anomaly in an identification result of a target component according to another aspect of the present disclosure includes acquiring a plurality of pieces of detection data detected by a chromatograph, the plurality of pieces of detection data corresponding, on a one-to-one basis, to a plurality of samples, and processing the plurality of pieces of detection data acquired in the acquiring. The processing includes acquiring an identification result indicating that peak information regarding signal intensity extracted from each of the plurality of pieces of detection data is identified as peak information regarding signal intensity corresponding to a target component, and detecting, in a case where there is outlier peak information among a plurality of pieces of the peak information identified for respective ones of the plurality of pieces of detection data, that an identification result corresponding to the outlier peak information is anomalous.

A non-transitory computer readable medium storing a detection program for detecting an anomaly in an identification result of a target component according to another aspect of the present disclosure, the detection program causing a computer to perform processing including acquiring a plurality of pieces of detection data detected by a chromatograph, the plurality of pieces of detection data corresponding, on a one-to-one basis, to a plurality of samples, and processing the plurality of pieces of detection data acquired in the acquiring. The processing includes acquiring an identification result indicating that peak information regarding signal intensity extracted from each of the plurality of pieces of detection data is identified as peak information regarding signal intensity corresponding to a target component, and detecting, in a case where there is outlier peak information among a plurality of pieces of the peak information identified for respective ones of the plurality of pieces of detection data, that an identification result corresponding to the outlier peak information is anomalous.

A detection system according to another aspect of the present disclosure includes a chromatograph, and a detection device that detects an anomaly in an identification result of a target component. The detection device includes an acquisition unit that acquires a plurality of pieces of detection data detected by a chromatograph, the plurality of pieces of detection data corresponding, on a one-to-one basis, to a plurality of samples, and a computing unit that processes the plurality of pieces of detection data acquired by the acquisition unit. The computing unit acquires an identification result indicating that peak information regarding signal intensity extracted from each of the plurality of pieces of detection data is identified as peak information regarding signal intensity corresponding to a target component, and detects, in a case where there is outlier peak information among a plurality of pieces of the peak information identified for respective ones of the plurality of pieces of detection data, that an identification result corresponding to the outlier peak information is anomalous.

The foregoing and other objects, features, aspects, and advantages of the present invention will become more apparent from the following detailed description of the present invention when taken in conjunction with the accompanying drawings.

### BRIEF DESCRIPTION OF THE DRAWINGS

FIG. 1 is a diagram illustrating a configuration of a detection system and configuration of a detection device according to a first embodiment.

FIG. 2 is a flowchart illustrating processing for acquiring an identification result.

FIG. 3 is a diagram illustrating a display example of a chromatogram generated by the detection device in the first embodiment.

FIG. 4 is a diagram illustrating an example of a table of peak information in the first embodiment.

FIG. 5 is a flowchart illustrating processing for detecting an anomaly in the identification result.

FIG. 6 is a diagram illustrating a display example of a chromatogram displayed after the flowchart in FIG. 5 is run.

FIG. 7 is a diagram illustrating an example of a table of peak information displayed after the flowchart in FIG. 5 is run.

FIG. 8 is a diagram illustrating a display example of a chromatogram generated by a detection device in a second embodiment.

FIG. 9 is a diagram illustrating an example of a table of peak information in the second embodiment.

FIG. 10 is a diagram illustrating a display example of a chromatogram displayed after the flowchart in FIG. 5 is run in the second embodiment.

FIG. 11 is a diagram illustrating an example of a table of peak information displayed after the flowchart in FIG. 5 is run in the second embodiment.

### DESCRIPTION OF THE PREFERRED EMBODIMENTS

### First Embodiment

The present embodiment will be described in detail with reference to the drawings. Note that the same or corresponding parts in the drawings are denoted by the same reference numerals, and no redundant description will be given of such parts in principle.

### <Overall Configuration of Detection System and Detection Device>

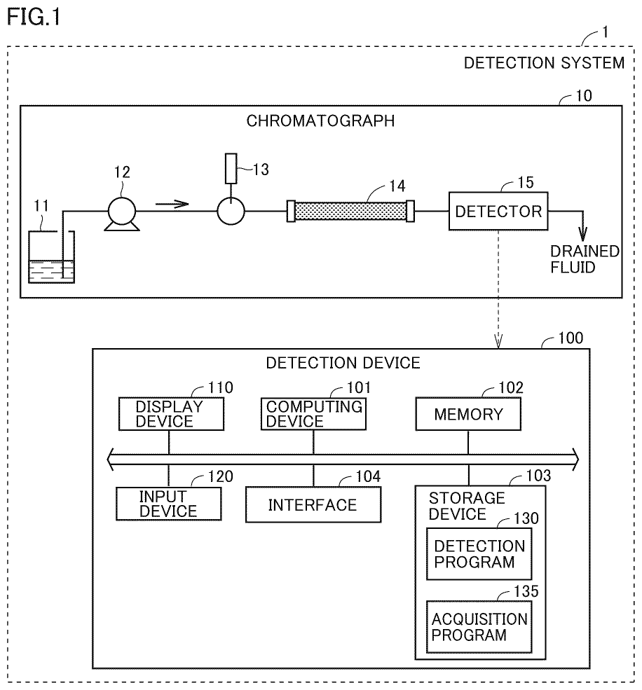

With reference to FIG. 1, a configuration of a detection system 1 and configuration of a detection device 100 according to the first embodiment will be described. FIG. 1 is a diagram illustrating the configuration of detection system 1 and the configuration of detection device 100 according to the first embodiment. As illustrated in FIG. 1, detection system 1 includes a chromatograph 10 and detection device 100.

Chromatograph 10 includes a container 11, a feed pump 12, an injector 13, a column 14, and a detector 15. Container 11 holds a mobile phase. Feed pump 12 sucks the mobile phase from container 11 and feeds the mobile phase at a constant flow rate. Injector 13 injects a sample to be analyzed into the mobile phase fed by feed pump 12.

Column 14 holds a stationary phase and separates various components contained in the sample injected by injector 13. Detector 15 detects components eluted from column 14. As detector 15, for example, an absorbance detector (photo diode array (PDA) detector), a fluorescence detector, a refractive index detector, a conductivity detector, a mass spectrometer, or the like is used. Detection data indicating signal intensity corresponding to a component in the sample detected by detector 15 is output to detection device 100.

Note that chromatograph 10 according to the first embodiment is a liquid chromatograph (LC) using a liquid as the mobile phase, or alternatively, chromatograph 10 may be another chromatograph such as a gas chromatograph using a gas as the mobile phase.

In chromatograph 10, the sample to be analyzed is injected into the mobile phase by injector 13. The sample thus injected reaches column 14 along with the flow of the mobile phase fed by feed pump 12 and passes through column 14. Various components contained in the sample pass through column 14 at different times on the basis of their affinity with the stationary phase or the mobile phase. For example, a time (also referred to as “retention time”) taken for a component that easily adsorbs onto the stationary phase to pass through column 14 is long as compared to a component that is less likely to adsorb onto the stationary phase, among the components contained in the sample. Accordingly, various components contained in the sample are separated in the time direction by column 14.

Eluate containing a component separated in column 14 is introduced from column 14 to detector 15. Detector 15 outputs detection data indicating signal intensity corresponding to a concentration (amount) of the component introduced by column 14. The detection data is processed by detection device 100 to generate a chromatogram. Note that a solution that has passed through detector 15 is drained as a waste fluid.

Detection device 100 may be a general-purpose computer or a computer designed specifically for detection system 1 for processing detection data output from chromatograph 10. Detection device 100 includes a computing device 101, a memory 102, a storage device 103, an interface 104, a display device 110, and an input device 120.

Computing device 101 is an example of a “computing unit”. Computing device 101 is a computing entity (computer) that runs various programs to perform various types of processing. Computing device 101 includes, for example, a processor such as a central processing unit (CPU) or a micro-processing unit (MPU). Note that the processor that is an example of computing device 101 has functions of running programs to perform various types of processing, but some or all of the functions may be implemented using a dedicated hardware circuit such as an application specific integrated circuit (ASIC) or a field-programmable gate array (FPGA).

The “processor” is not limited to a processor in a narrow sense that performs processing in a stored-program manner such as a CPU or an MPU, and may include a hardwired circuit such as an ASIC or an FPGA. Therefore, the “processor” that is an example of computing device 101 can be called processing circuitry in which processing is predefined by a computer-readable code and/or a hardwired circuit.

Note that computing device 101 may include one chip or a plurality of chips. Furthermore, the processor and the associated processing circuitry may be implemented by a plurality of computers interconnected in a wired or wireless manner over a local area network, a wireless network, or the like. The processor and the associated processing circuitry may be implemented by a cloud computer that performs, at a remote site, computation on the basis of input data and outputs a result of the computation to another device located at a remote site.

Memory 102 includes a volatile storage area (for example, working area) that temporarily stores a program code, a work memory, and the like when computing device 101 runs various programs. Examples of memory 102 include volatile memories such as a dynamic random access memory (DRAM) and a static random access memory (SRAM), and non-volatile memories such as a read only memory (ROM) and a flash memory.

Storage device 103 stores various programs to be run by computing device 101, various data, and the like. Storage device 103 may include one or a plurality of non-transitory computer readable media or one or a plurality of computer readable storage media. Examples of storage device 103 include a hard disk drive (HDD) and a solid state drive (SSD).

Storage device 103 according to the first embodiment stores a detection program 130 for causing computing device 101 to perform processing for detecting an anomaly in detection data acquired from chromatograph 10, and an acquisition program 135 for acquiring an identification result of a target component to be described later.

Interface 104 transmits and receives data to and from an external device or external equipment via wired communication or wireless communication. For example, interface 104 communicates with chromatograph 10 to acquire the detection data output from chromatograph 10. Further, interface 104 may be a communication device that communicates with a cloud server (not illustrated) to transmit the detection data acquired from chromatograph 10 to the cloud server or causes computing device 101 to transmit a result of the processing for detecting anomalous data to the cloud server.

Furthermore, interface 104 may transmit and receive data to and from display device 110 or input device 120, which acts as a user interface, via wired communication or wireless communication. Detection device 100 may include one or a plurality of interfaces 104 in accordance with the number of communication targets.

Display device 110 is, for example, a display including a liquid crystal panel or the like, and displays the result of processing for detecting anomalous data performed by detection device 100. Input device 120 is, for example, a pointing device such as a keyboard or a mouse, and receives a command from the user. In a case where a touchscreen is used as the user interface, display device 110 and input device 120 may be integrated into a single device. Note that display device 110 and input device 120 may be provided separately from detection device 100.

### <Acquisition of Identification Result>

In detection system 1 configured as described above, detection device 100 acquires, in time series, detection data indicating signal intensity corresponding to a component in the sample detected by chromatograph 10 via interface 104. Detection device 100 generates a chromatogram indicating temporal changes in signal intensity on the basis of the acquired detection data. The chromatogram includes a plurality of peak-shaped waveforms (also simply referred to as “peaks”). The plurality of peaks included in the chromatogram correspond, on a one-to-one basis, to a plurality of components in the sample.

Detection device 100 according to the first embodiment automatically determines which one of the plurality of peaks included in the chromatogram corresponds to the target component using a peak detection algorithm. The target component is a component to be analyzed among the plurality of components contained in the sample, and is preset by the user of detection system 1.

As described above, the components in the sample are separated by column 14. The peaks in the chromatogram are each formed with a unique retention time of the corresponding component. A theoretical retention time of the target component (also referred to as “theoretical retention time”) is input by the user and stored in storage device 103 in advance.

Detection device 100 automatically identifies a peak formed at a retention time close to the theoretical retention time of the target component from among the plurality of peaks in the chromatogram as the peak corresponding to the target component. As described above, identifying one peak from among the plurality of peaks included in the chromatogram as the peak of the target component is referred to as “identification”.

Detection device 100 acquires information regarding the peak identified as the peak of the target component (also referred to as “peak information”), as an identification result. The peak information includes, for example, information such as maximum signal intensity, a retention time when the signal intensity is at the maximum (also referred to as “peak retention time”), a retention time when the signal intensity starts to rise (referred to as “peak start retention time”), a retention time when the signal intensity stops falling (referred to as “peak end retention time”), an area of a peak shape (referred to as “peak area”), a position of a baseline to be described later, and intensity obtained by subtracting intensity of the baseline from the maximum signal intensity (also referred to as “peak height”).

Detection device 100 calculates the concentration of the target component contained in the sample using the peak height, the peak area, and a calibration curve prepared in advance. As described above, detection device 100 of the first embodiment acquires the identification result indicating that the peak information regarding the signal intensity extracted from the detection data is identified as the peak information regarding the signal intensity corresponding to the target component.

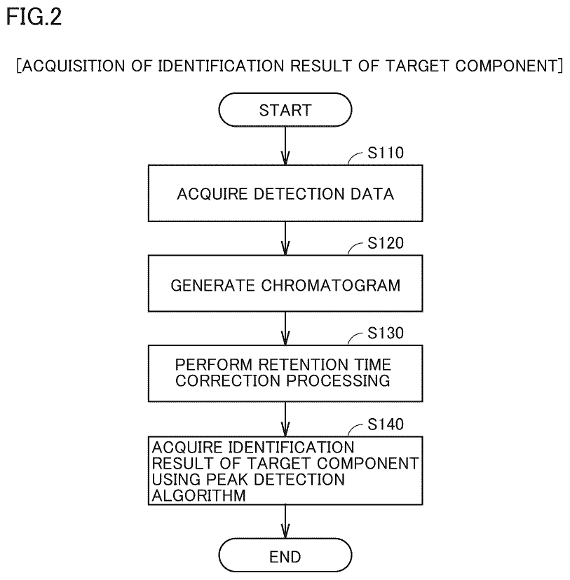

FIG. 2 is a flowchart illustrating processing for acquiring the identification result. Processing steps illustrated in FIG. 2 are implemented by acquisition program 135 for acquiring the identification result run by computing device 101.

As illustrated in FIG. 2, computing device 101 acquires detection data indicating signal intensity corresponding to a component in the sample detected by chromatograph 10 (step S110). Computing device 101 generates a chromatogram on the basis of the detection data (step S120).

Computing device 101 performs retention time correction processing (step S130). Even when the same component passes through column 14, its retention time in the chromatogram may vary due to deterioration of column 14 or the like. The processing in step S130 is processing for correcting variations in retention time due to deterioration of column 14 or the like.

In the first embodiment, variations in retention time are corrected using a standard substance (for example, alkanes). In the first embodiment, a chromatogram is generated on the basis of a mixture of the standard substance and the sample. A retention time of the standard substance with no deterioration occurring in column 14 is input to detection device 100 in advance. Detection device 100 determines a degree of deterioration of column 14 using the retention time of the standard substance in the generated chromatogram and the retention time of the standard substance with no deterioration occurring in column 14, and corrects the retention time of the entire chromatogram.

In one aspect, the retention time may be corrected using a retention time of any desired component with no deterioration occurring in column 14 and a retention time when the desired component is actually detected without using the standard substance.

In another aspect, the retention time may be corrected by means of correction of the flow rate of the mobile phase. As described above, detection device 100 of the first embodiment performs, with variations in retention time due to an external factor such as deterioration of column 14 taken into account, the correction processing in advance on the retention time in the chromatogram.

Returning to FIG. 2, computing device 101 acquires, using the peak detection algorithm, the identification result of the target component from the plurality of peaks included in the chromatogram in which the retention time has been corrected in step S130 (step S140), and exits the processing. The processing in steps S110 to S140 illustrated in FIG. 2 is processing for acquiring the identification result of one target component in a single sample.

### <Identification Result for Each of Plurality of Samples>

In FIG. 2, the processing for acquiring the identification result of one target component in a single sample has been described. In the first embodiment, the identification result of the target component is acquired from a plurality of samples. That is, detection device 100 of the first embodiment runs the flowchart illustrated in FIG. 2 as many times as the number of the plurality of samples prepared in advance. As described above, in analysis in the field of metabolomics and pesticide residue analysis, the number of samples is in the hundreds.

More specifically, in pesticide residue analysis for analyzing whether or not pesticides are contained in agricultural products to be shipped, some of the products to be shipped are randomly selected as samples. Hereinafter, an example where 100 products to be shipped are selected as samples will be described. In this case, detection device 100 runs the flowchart in FIG. 2 for each of the 100 products to be shipped. The 100 products to be shipped are agricultural products of the same type. More specifically, when the products to be shipped are, for example, bananas, the 100 products to be shipped do not include agricultural products other than bananas, and all the 100 products to be shipped are bananas. Therefore, the 100 samples basically have common components.

In the first embodiment, a case where a target component A that is a pesticide is set as the target component will be described. A theoretical retention time of target component A is 7.14 minutes. In the first embodiment, the flowchart in FIG. 2 is run to generate 100 chromatograms for the 100 products to be shipped. Detection device 100 performs, on each of the 100 chromatograms, identification processing for automatically identifying a peak formed at a retention time close to 7.14 minutes as the peak corresponding to target component A.

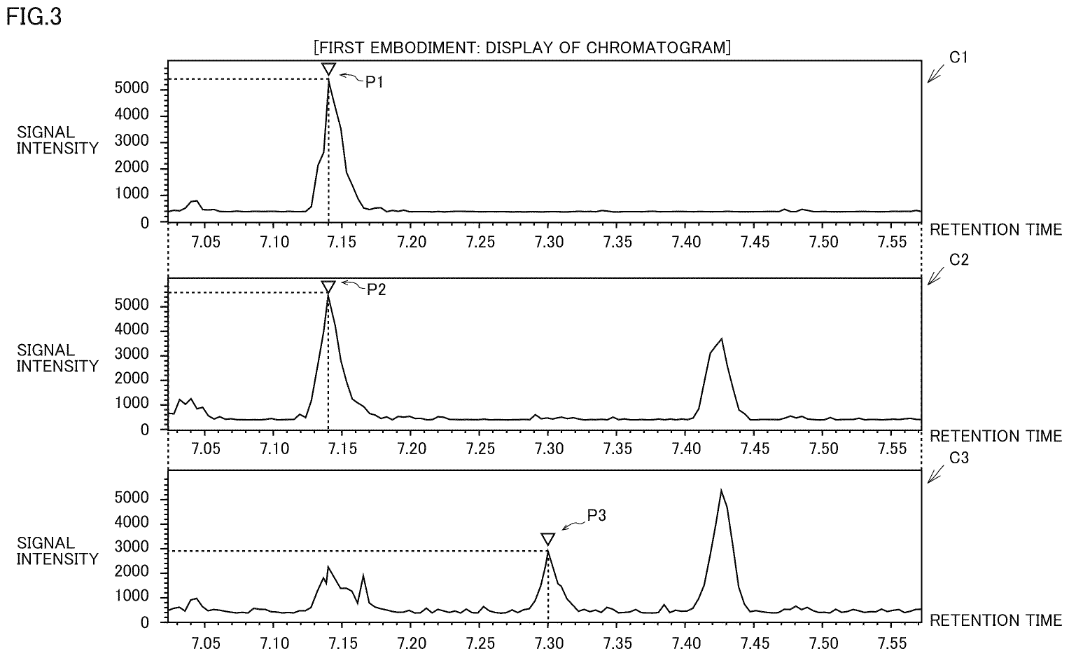

FIG. 3 is a diagram illustrating a display example of a chromatogram generated by detection device 100 in the first embodiment. FIG. 3 illustrates chromatograms C1, C2, and C3 corresponding to three samples S1, S2, and S3 among the 100 samples. In each of chromatograms C1, C2, and C3, the horizontal axis represents a retention time (minutes), and the vertical axis represents signal intensity (absorbance). Chromatograms C1 to C3 illustrated in FIG. 3 are displayed as image data to the user by display device 110.

As described above, the 100 samples are agricultural products of the same type. Therefore, most of the components contained in the 100 samples are common components. In the example of the first embodiment, an example where most of the 100 samples contain target component A will be described. As illustrated in FIG. 3, chromatograms C1 to C3, however, may be different in peak shape included in chromatograms C1 to C3 from each other due to contaminants mixed into the samples, variations in components, or the like.

In the example in FIG. 3, in chromatograms C1 and C2, a peak exceeding signal intensity “5000” appears at the retention time “7.14 minutes”. On the other hand, in chromatogram C3, at the retention time “7.14 minutes”, a peak almost equal to signal intensity “2000” that is lower than the signal intensity “5000” appears. Further, in chromatogram C3, a peak almost equal to signal intensity “3000” appears at a retention time “7.30 minutes”. On the other hand, in chromatograms C1 and C2, no peak appears at the retention time “7.30 minutes”.

As described above, even samples S1, S2, and S3 of the same type collected under the same conditions are different in peak shape from each other due to the mixing of contaminants or variations in components. As described above, detection device 100 of the first embodiment identifies target component A using the peak detection algorithm for each of chromatograms C1, C2, and C3. In FIG. 3, white triangular images P1, P2, and P3 are displayed at peaks in the respective chromatograms C1 to C3. Images P1, P2, and P3 indicate that the peaks indicated by images P1, P2, and P3 are identified as target component A.

That is, image P1 indicates that the peak at the retention time “7.14 minutes” in chromatogram C1 is the peak of target component A. Image P2 indicates that the peak at the retention time “7.14 minutes” in chromatogram C2 is the peak of target component A. On the other hand, image P3 indicates that the peak at the retention time “7.30 minutes” in chromatogram C3 is the peak of target component A.

As illustrated in FIG. 3, in chromatogram C3, a wrong peak (peak almost equal to the signal intensity “3000”) has been identified as target component A. This is because sample S3 is smaller in concentration of target component A than the other samples, and contaminants having the retention time “7.30 minutes” are mixed into sample S3 due to variations in components.

Therefore, detection device 100 wrongly identifies the peak corresponding to the contaminants appearing at the retention time “7.30 minutes” as target component A. As described above, in the example illustrated in FIG. 3, target component A is automatically identified using the peak detection algorithm, so that a wrong peak is identified as target component A for some samples. Therefore, in the first embodiment, wrong identification is detected as an anomaly by the following method.

### <Processing for Detecting Anomaly in Identification Result>

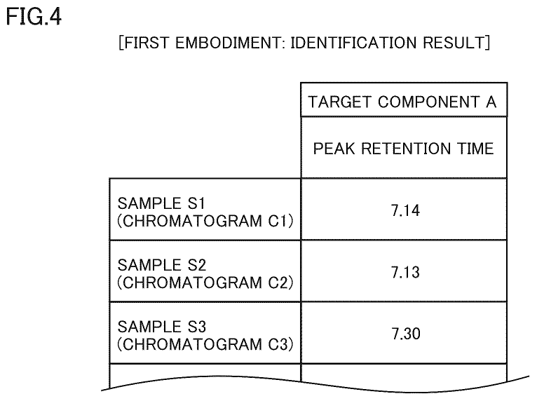

Detection device 100 acquires peak information regarding target component A identified in each of chromatograms C1 to C3. FIG. 4 is a diagram illustrating an example of a table of peak information in the first embodiment. The table illustrated in FIG. 4 is displayed as image data to the user by display device 110, in a manner similar to FIG. 3. In the first embodiment, the peak information corresponds to a peak retention time. Detection device 100 acquires the peak retention time corresponding to the identified peak and generates the table illustrated in FIG. 4. The table illustrated in FIG. 4 is stored in storage device 103.

As illustrated in FIG. 4, the peak retention time of target component A in chromatogram C1 is a retention time “7.14 minutes”. The peak retention time of target component A in chromatogram C2 is a retention time “7.14 minutes”. The peak retention time of target component A in chromatogram C3 is a retention time “7.30 minutes”. Although not illustrated, the table illustrated in FIG. 4 includes peak retention times of the 100 samples.

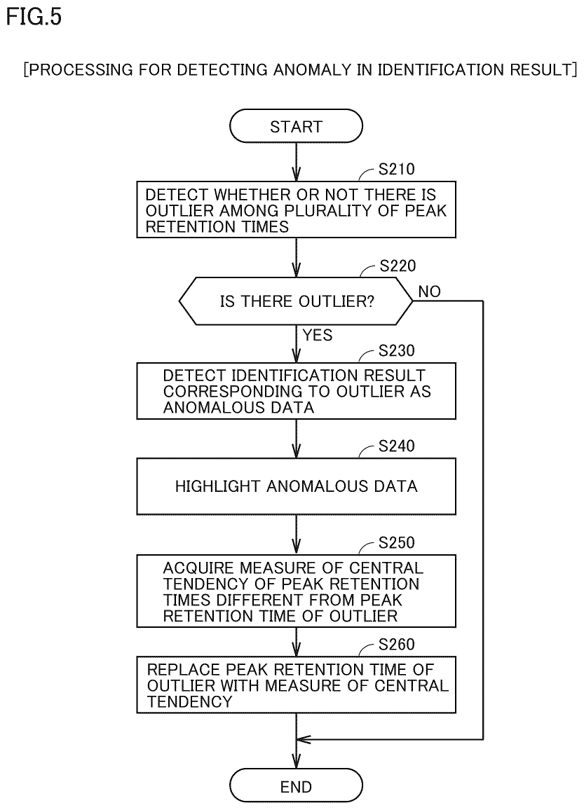

Subsequently, detection device 100 runs detection program 130 for performing the anomaly detection processing. FIG. 5 is a flowchart illustrating the processing for detecting an anomaly in the identification result. The processing steps illustrated in FIG. 5 are implemented by detection program 130 run by computing device 101.

Computing device 101 detects whether or not there is an outlier among the plurality of peak retention times illustrated in FIG. 4 (step S210). In the first embodiment, computing device 101 determines whether or not there is an outlier using the Hotelling's T-squared method. More specifically, computing device 101 calculates a mean μ of peak retention times χᵢ of all N samples (100 samples in the first embodiment). Further, computing device 101 calculates an unbiased variance σ² of the peak retention times of all the 100 samples. Unbiased variance σ² is expressed by the following Formula 1.

$${σ}^{2} = \frac{1}{N - 1} {\sum }_{i} {( {x}_{i} - μ )}^{2} \qquad [ Math . 1 ]$$

Computing device 101 calculates an anomaly score a for each peak retention time χᵢ using mean μ and unbiased variance σ². Anomaly score a is expressed by the following Formula 2.

$$a ( {x}_{i} ) = \frac{{( {x}_{i} - μ )}^{2}}{{σ}^{2}} \qquad [ Math . 2 ]$$

When anomaly score a of a peak retention time exceeds a predetermined threshold, computing device 101 determines that the peak retention time is an outlier. When the anomaly score of the peak retention time is less than or equal to the threshold, computing device 101 determines that the peak retention time is not an outlier. The threshold is, for example, 10.

Returning to FIG. 5, when there is no outlier (NO in step S220), computing device 101 exits the processing. When there is an outlier (YES in step S220), computing device 101 detects an identification result corresponding to the outlier as anomalous data (step S230). Computing device 101 highlights the anomalous data (step S240). More specifically, computing device 101 causes display device 110 to highlight the peak retention time of the outlier as compared to other peak retention times different from the peak retention time of the outlier.

Computing device 101 acquires a measure of central tendency on the basis of the peak retention times different from the peak retention time of the outlier (step S250). The measure of central tendency is a value representing a normal value that is not an outlier, and is, for example, a mean of the peak retention times different from the peak retention time of the outlier. Specifically, in the example of the first embodiment, when only the peak retention time of sample S3 is detected as an outlier, a mean of the peak retention times of the 99 samples other than sample S3 is calculated as a measure of central tendency. In the example of the first embodiment, the retention time “7.14 minutes” that is the same as the theoretical retention time is calculated as the measure of central tendency. Thereafter, computing device 101 replaces the peak retention time of the outlier with the measure of central tendency (step S260).

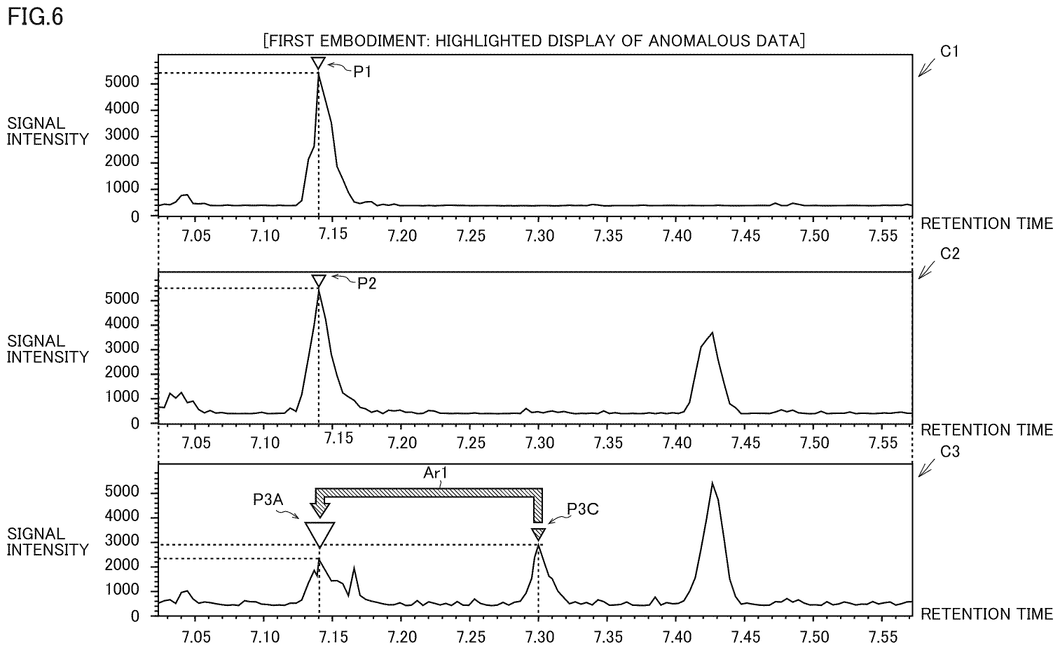

FIG. 6 is a diagram illustrating a display example of a chromatogram displayed after the flowchart in FIG. 5 is run. As illustrated in FIG. 6, computing device 101 displays an image P3C instead of triangular image P3 indicating a wrong peak. Unlike image P3, image P3C is provided with color information. For example, image P3C is displayed in red. As described above, since images P1 and P2 are white, red image P3C is highlighted. Accordingly, detection device 100 enables the user to easily recognize that the peak indicated by image P3 is wrong.

Furthermore, as illustrated in FIG. 6, computing device 101 re-identifies, using the measure of central tendency replaced in step S260, a peak present near the measure of central tendency as the peak of target component A. FIG. 6 illustrates an image P3A indicating the peak identified on the basis of the measure of central tendency. Image P3A is displayed larger than images P1 and P2. Accordingly, detection device 100 enables the user to easily grasp the position of the peak after the outlier is replaced with the measure of central tendency. Furthermore, in the example of the first embodiment, an arrow image Ar1 indicating the positions of both the peaks before and after the outlier is replaced with the measure of central tendency is displayed. As described above, in the first embodiment, since arrow image Ar1 is displayed, the user can easily grasp the positions of the peaks before and after the outlier is replaced with the measure of central tendency.

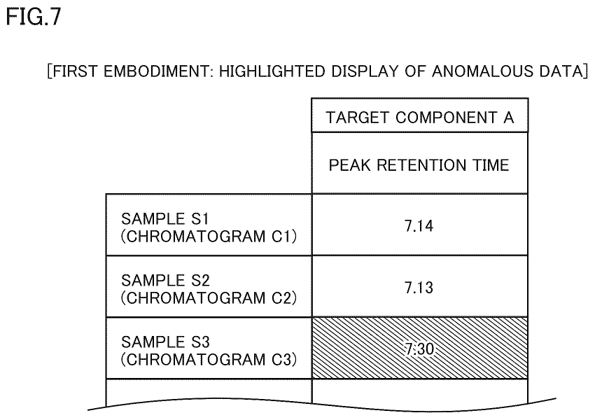

FIG. 7 is a diagram illustrating an example of a table of peak information displayed after the flowchart in FIG. 5 is run. As illustrated in FIG. 7, color information is added to a background of a cell showing the peak retention time of chromatogram C3 on which wrong identification has been made. Specifically, in the table in FIG. 7, the background of the cell showing the peak retention time “7.30 minutes” is red. Accordingly, detection device 100 enables the user to easily recognize that the peak retention time “7.30 minutes” is the retention time of the wrong peak.

As described above, detection device 100 of the first embodiment can detect, as anomalous data, an identification result wrongly identified using the outlier. Accordingly, in the first embodiment, it is possible to identify the peak of the chromatogram correctly as the peak of the target component by displaying anomalous data to the user to urge the user to correct the anomalous data. Further, as described above, it is possible to identify, by causing detection device 100 to automatically replace the outlier with the measure of central tendency, the peak of the chromatogram automatically and correctly as the peak of the target component without causing the user to perform correction work. Furthermore, in the example of the first embodiment, since whether or not there is an anomaly is determined on the basis of whether or not there is an outlier, it is possible to suppress a difference among users in determination as to whether or not the identification result is anomalous as compared to a case where whether or not there is an anomaly is determined by means of visual identification by each user.

### Second Embodiment

In the first embodiment, the example where whether or not there is an outlier is determined on the basis of peak retention times, and only one target component A in one sample is analyzed has been described. In the second embodiment, an example where whether or not there is an outlier is determined on the basis of information different from the peak retention times and a plurality of target components are analyzed will be described. Note that, in the second embodiment, no description will be given below of the same configuration as the configuration of the first embodiment.

In the second embodiment, the peak information used for detecting an outlier includes the peak start retention time and the peak end retention time. As described above, the peak start retention time is a retention time when signal intensity starts to rise, and the peak end retention time is a retention time when the signal intensity stops falling. The peak start retention time and the peak end retention time are automatically detected by the peak detection algorithm that has read a chromatogram. More specifically, detection device 100 detects, as the “peak start retention time”, a retention time at which the signal intensity less than a predetermined threshold increases to be greater than or equal to the predetermined threshold. Further, detection device 100 detects, as the “peak end retention time”, a retention time at which signal intensity greater than the predetermined threshold decreases to be less than or equal to the predetermined threshold.

In the second embodiment, a target component B is to be analyzed in addition to target component A. A theoretical retention time of target component B is “8.05 minutes”. Further, a theoretical peak start retention time of target component B is “8.01 minutes”, and a theoretical peak end retention time is “8.09 minutes”.

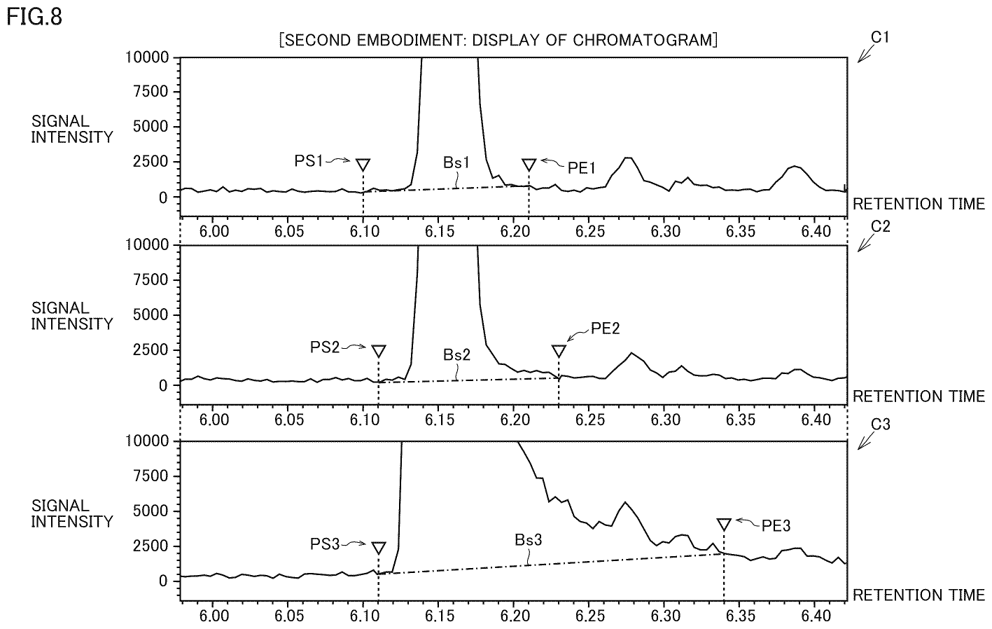

FIG. 8 is a diagram illustrating a display example of a chromatogram generated by detection device 100 in the second embodiment. FIG. 8 illustrates chromatograms C1, C2, and C3 corresponding to three samples S1, S2, and S3 among the 100 samples, in a manner similar to FIG. 3. In FIG. 8, only a peak identified as target component A is illustrated, and a peak identified as target component B is not illustrated.

As illustrated in FIG. 8, in chromatogram C1, signal intensity starts to rise at a retention time “6.10 minutes” and stops falling at a retention time “6.21 minutes” in a peak identified as target component A. An image PS1 indicates that the peak start retention time of chromatogram C1 is “6.10 minutes”. An image PE1 indicates that the peak end retention time of chromatogram C1 is “6.21 minutes”. As illustrated in FIG. 8, detection device 100 draws a baseline Bs1 between the retention time at which the signal intensity starts to rise and the retention time at which the signal intensity stops falling in chromatogram C1. Baseline Bs1 is a line used in calculation of the peak area and the peak height, and is drawn by detection device 100.

Further, in chromatogram C2, signal intensity starts to rise at a retention time “6.11 minutes” and stops falling at a retention time “6.23 minutes” in a peak identified as target component A. An image PS2 indicates that the peak start retention time of chromatogram C2 is “6.11 minutes”. An image PE2 indicates that the peak end retention time of chromatogram C2 is “6.23 minutes”. As illustrated in FIG. 8, a baseline Bs2 is drawn between the retention time at which the signal intensity starts to rise and the retention time at which the signal intensity stops falling in chromatogram

C2.

Furthermore, in chromatogram C3, signal intensity starts to rise at a retention time “6.11 minutes” and stops falling at a retention time “6.34 minutes” in a peak identified as target component A. An image PS3 indicates that the peak start retention time of chromatogram C3 is “6.11 minutes”. An image PE3 indicates that the peak end retention time of chromatogram C2 is “6.34 minutes”. As illustrated in FIG. 8, a baseline Bs3 is drawn between the retention time at which the signal intensity starts to rise and the retention time at which the signal intensity stops falling in chromatogram C3.

In the second embodiment, sample S3 contains contaminants having a peak between a retention time “6.25 minutes” and a retention time “6.35 minutes”. Detection device 100 therefore detects that the peak end retention time of the peak of target component A in the chromatogram C3 is “6.34 minutes” that is relatively large as compared to chromatograms C1 and C2. This causes detection device 100 to wrongly calculate the peak area of target component A in chromatogram C3. That is, detection device 100 acquires a wrong identification result for chromatogram C3.

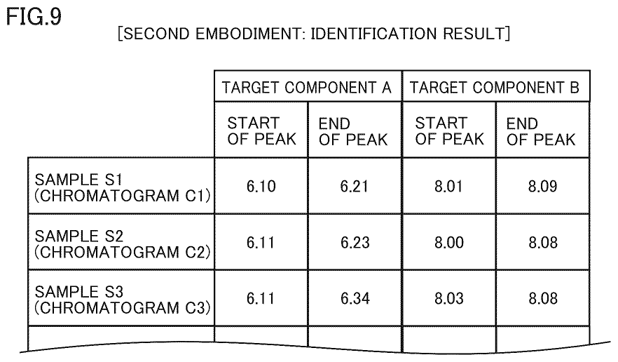

FIG. 9 is a diagram illustrating an example of a table of peak information in the second embodiment. Detection device 100 of the second embodiment acquires, as peak information, the peak start retention time and the peak end retention time of the peak of target component A identified in each of chromatograms C1 to C3. Detection device 100 acquires the peak start retention time and the peak end retention time of the identified peak using the peak detection algorithm, and generates the table illustrated in FIG. 9. The table illustrated in FIG. 9 is stored in storage device 103, in a manner similar to FIG. 4.

As illustrated in FIG. 9, the peak start retention time of target component A in chromatogram C1 is a retention time “6.10 minutes”. Further, the peak end retention time of target component A in chromatogram C1 is a retention time “6.21 minutes”. The peak start retention time of target component A in chromatogram C2 is a retention time “6.11 minutes”. Further, the peak end retention time of target component A in chromatogram C2 is a retention time “6.23 minutes”. The peak start retention time of target component A in chromatogram C3 is a retention time “6.11 minutes”. Further, the peak end retention time of target component A in chromatogram C3 is a retention time “6.34 minutes”.

As described above, detection device 100 of the second embodiment analyzes target component B in addition to target component A. Detection device 100 of the second embodiment automatically identifies the peak corresponding to target component B, in a manner similar to target component A, using the peak detection algorithm, and generates the table illustrated in FIG. 9 from the identification result.

As illustrated in FIG. 9, the peak start retention time of target component B in chromatogram C1 is a retention time “8.01 minutes”. Further, the peak end retention time of target component B in chromatogram C1 is a retention time “8.09 minutes”. The peak start retention time of target component B in chromatogram C2 is a retention time “8.00 minutes”. Further, the peak end retention time of target component B in chromatogram C2 is a retention time “8.08 minutes”. The peak start retention time of target component B in chromatogram C3 is a retention time “8.03 minutes”. Further, the peak end retention time of target component B in chromatogram C3 is a retention time “8.08 minutes”. In the example in FIG. 9, chromatograms C1 to C3 have no anomaly in the identification result of target component B.

Also in the second embodiment, detection device 100 runs the flowchart in FIG. 5. In the second embodiment, the peak information to be subjected to outlier detection is not the peak retention time but the peak start retention time and the peak end retention time. Further, in the second embodiment, since two components, that is, target components A and B, are set as target components, the flowchart in FIG. 5 is run twice corresponding to target components A and B for one sample.

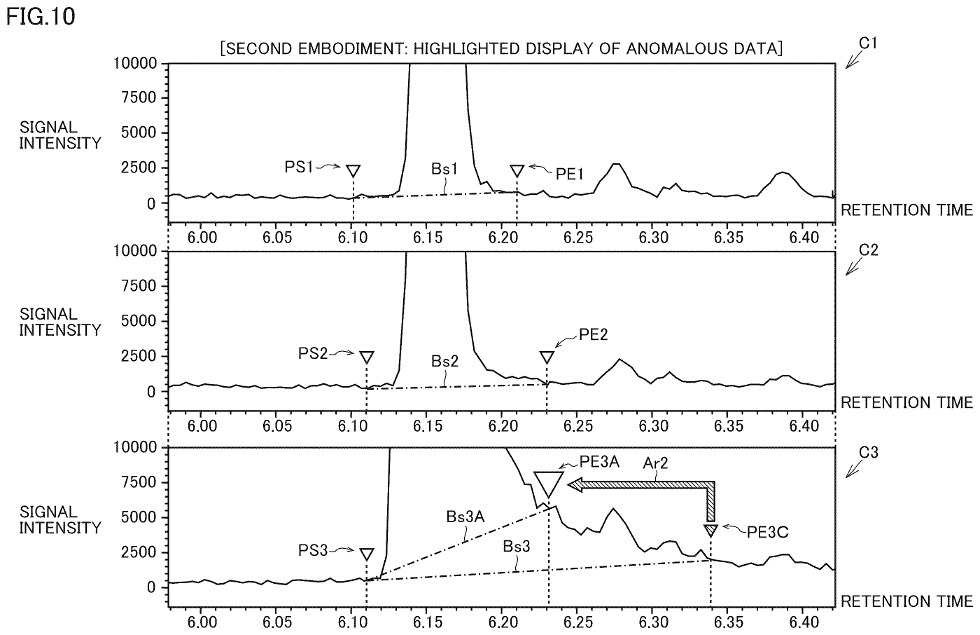

FIG. 10 is a diagram illustrating a display example of a chromatogram displayed after the flowchart in FIG. 5 is run in the second embodiment. As illustrated in FIG. 10, computing device 101 displays an image PE3C instead of triangular image PE3 indicating a wrong peak as the peak end retention time of target component A. Image PE3C is highlighted in red. Accordingly, also in the second embodiment, detection device 100 enables the user to recognize that the peak end retention time indicated by image PE3 is wrong.

Furthermore, as illustrated in FIG. 10, computing device 101 re-identifies, using the measure of central tendency replaced in step S260, a peak end retention time present near the measure of central tendency as the peak end retention time of target component A. FIG. 10 illustrates an image PE3A indicating the peak identified on the basis of the measure of central tendency. Image PE3A is highlighted as compared to the other triangular images. Accordingly, detection device 100 enables the user to easily grasp the peak end retention time after being replaced with the measure of central tendency. Further, as illustrated in FIG. 10, detection device 100 draws a baseline Bs3A on the basis of the fact that the peak end retention time is changed on the basis of the measure of central tendency. Furthermore, also in the second embodiment, an arrow image Ar2 is displayed, so that the user can easily grasp the positions of the peaks before and after the outlier is replaced with the measure of central tendency.

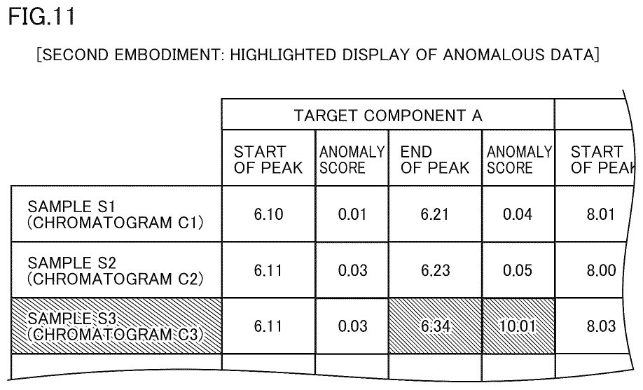

FIG. 11 is a diagram illustrating an example of a table of peak information displayed after the flowchart in FIG. 5 is run in the second embodiment. As illustrated in FIG. 11, color information is added to a background of a cell of the peak end retention time of chromatogram C3 on which wrong identification has been made. Specifically, in the table in FIG. 11, a background of a cell of the peak retention time “6.34 minutes” is highlighted in red.

Further, in the second embodiment, an anomaly score calculated on the basis of the above-described Hotelling's T-squared method is displayed. As illustrated in FIG. 11, an anomaly score of the peak start retention time of target component A in chromatogram C1 is a retention time “0.01”, and an anomaly score of the peak end retention time of target component A in chromatogram C1 is a retention time “0.04”. Further, an anomaly score of the peak start retention time of target component A in chromatogram C2 is a retention time “0.03”, and an anomaly score of the peak end retention time of target component A in chromatogram C2 is a retention time “0.05”.

Furthermore, an anomaly score of the peak start retention time of target component A in chromatogram C3 is a retention time “0.03”, and an anomaly score of the peak end retention time of target component A in chromatogram C3 is a retention time “10.01”. Detection device 100 determines that the peak end retention time of target component A in chromatogram C3 of which the anomaly score exceeds a threshold “10” is anomalous.

In the second embodiment, detection device 100 highlights not only the cell of the peak retention time “6.34 minutes”, but also a background of a cell of “sample S3 (chromatogram C3)” indicating a sample and a background of a cell of the anomaly score “10.01” in red. This enables, in the second embodiment, the user to easily grasp which sample suffers an anomaly or an anomaly degree when compared to other samples. Note that, in a case where a plurality of samples having outliers have been detected, detection device 100 may be able to sort the samples into a display order based on their respective anomaly degrees. Accordingly, in the second embodiment, it is possible to display the samples to the user in descending order of the anomaly degrees.

As described above, also in the second embodiment, an identification result wrongly identified using an outlier is easily detected as an anomaly. Accordingly, also in the second embodiment, the peak in the chromatogram can be correctly identified as the peak of the target component.

### <Modification>

Hereinafter, other modes partially modified from the above-described embodiments will be described.

In the above-described examples, the peak information includes the peak retention time, the peak start retention time, the peak end retention time, the peak area, and the like. The information included in the peak information, however, is not limited to the above-described information. In one aspect, the peak information includes a period from the peak start retention time to the peak end retention time (also referred to as “peak width”), a period from the peak start retention time to the peak retention time (also referred to as “peak first half width”), a period from the peak retention time to the peak end retention time (also referred to as “peak second half width”), a magnitude of signal intensity when the signal intensity starts rising (also referred to as “peak start height”), and a magnitude of signal intensity when the signal intensity stops falling (also referred to as “peak end height”). The peak information may further include a peak width, a peak first half width, and a peak second half width at predetermined intensity (N %), or may further include a resolution indicating a degree of separation between a peak and an adjacent peak, or a separation factor, a retention factor, a theoretical plate number indicating column efficiency, a symmetry factor indicating a degree of peak symmetry, and the like.

In the above-described examples, the threshold value is “10” under the Hotelling's T-squared method, but the threshold may be other than “10”. For example, the threshold may be “5”, “20”, or “30”, and may be determined on the basis of an experiment.

In the example of the first embodiment, the peak retention time is used as the peak information and is to be subjected to outlier detection. The peak information to be subjected to outlier detection, however, may be other peak information described above, or may be, for example, a difference between the peak retention time and the theoretical retention time.

In the above-described examples, an agricultural product to be shipped is used as an example of the sample. Examples of the sample may include a standard sample prepared in advance that is used to generate a calibration curve for identifying the target component from the peak information. That is, some of the plurality of samples need not be real-world samples such as agricultural products that are actually shipped to the market, but may be the standard samples into which the target component is artificially mixed in order to acquire information regarding the target component.

In the above-described examples, the Hotelling's T-squared method is used as the method for detecting whether or not there is an outlier. In one aspect, an outlier, however, may be detected by other methods, and for example, a variance or a deviation from a mean may be simply used, or a k-nearest neighbor algorithm may be used.

In the above-described examples, as the image highlighting technique, image P3C is displayed with color information added, and image P3A is enlarged. The image highlighting technique, however, may be another technique, and may include, for example, blinking an image, changing the shape of an image from a triangle, and the like. Furthermore, in the above-described examples, with respect to the display of the tables in FIGS. 7 and 11, only an outlier before being replaced with the measure of central tendency is displayed, but the outlier may be displayed together with the measure of central tendency. Furthermore, in the above-described examples, red color information is added in a case where the anomaly score exceeds the threshold “10”. The color information, however, may be added stepwise in a manner that depends on the anomaly score. That is, detection device 100 may add yellow color information in a case where the anomaly score exceeds the threshold “5” and is less than or equal to the threshold “10”, and add red color information in a case where the anomaly score exceeds the threshold “10”.

### [Aspect]

It is to be understood by those skilled in the art that the plurality of exemplary embodiments described above are specific examples of the following aspects.

### (Clause 1)

A detection device according to an aspect includes:
an acquisition unit that acquires a plurality of pieces of detection data detected by a chromatograph, the plurality of pieces of detection data corresponding, on a one-to-one basis, to a plurality of samples; and
a computing unit that processes the plurality of pieces of detection data acquired by the acquisition unit, in which
the computing unit acquires an identification result indicating that peak information regarding signal intensity extracted from each of the plurality of pieces of detection data is identified as peak information regarding signal intensity corresponding to a target component, and detects, in a case where there is outlier peak information among a plurality of pieces of the peak information identified for respective ones of the plurality of pieces of detection data, that an identification result corresponding to the outlier peak information is anomalous.

The detection device according to clause 1 can correctly identify a peak in a chromatogram as the peak of the target component.

### (Clause 2)

In the detection device according to clause 1, the computing unit causes a display device to display the outlier peak information in an emphasized manner as compared to other peak information different from the outlier peak information.

The detection device according to clause 2 enables a user to recognize that the identified peak is wrong.

### (Clause 3)

In the detection device according to clause 1 or 2, the computing unit acquires a measure of central tendency on the basis of other peak information different from the outlier peak information, and
replaces the outlier peak information with the measure of central tendency.

The detection device according to clause 3 can replace the outlier with the measure of central tendency that represents a normal value.

### (Clause 4)

In the detection device according to clause 3, the computing unit causes a display device to display, in a recognizable manner, both the peak information before the outlier peak information is replaced with the measure of central tendency and the peak information after the outlier peak information is replaced with the measure of central tendency.

The detection device according to clause 4 enables the user to easily grasp the position of the peak before and after the outlier is replaced with the measure of central tendency.

### (Clause 5)

In the detection device according to any one of clauses 1 to 4, the peak information includes a retention time when signal intensity is at a maximum.

The detection device according to clause 5 can detect an anomalous identification using the peak retention time.

### (Clause 6)

In the detection device according to any one of clauses 1 to 5, the peak information includes at least one of a retention time when signal intensity starts to rise, a retention time when signal intensity stops falling, or a position of a baseline.

The detection device according to clause 6 can detect an anomalous identification using the peak start retention time or the peak end retention time.

### (Clause 7)

In the detection device according to any one of clauses 1 to 6, the computing unit corrects in advance a retention time included in each of the plurality of pieces of detection data.

The detection device according to clause 7 can correct in advance variations in retention time due to column deterioration or the like.

### (Clause 8)

In the detection device according to any one of clauses 1 to 7, the detection device determines whether or not there is the outlier peak information among the plurality of pieces of the peak information using a Hotelling's T-squared method.

The detection device according to clause 8 can determine the outlier using the Hotelling's T-squared method.

### (Clause 9)

In the detection device according to any one of clauses 1 to 8, the plurality of samples include a standard sample used to generate information for identifying the target component from the peak information.

The detection device according to clause 9 can detect an anomalous identification using the standard sample.

### (Clause 10)

A detection method for causing a computer to detect an anomaly in an identification result of a target component according to an aspect includes acquiring a plurality of pieces of detection data detected by a chromatograph, the plurality of pieces of detection data corresponding, on a one-to-one basis, to a plurality of samples, and processing the plurality of pieces of detection data acquired in the acquiring, in which
the processing includes:
   acquiring an identification result indicating that peak information regarding signal intensity extracted from each of the plurality of pieces of detection data is identified as peak information regarding signal intensity corresponding to a target component; and
   detecting, in a case where there is outlier peak information among a plurality of pieces of the peak information identified for respective ones of the plurality of pieces of detection data, that an identification result corresponding to the outlier peak information is anomalous.

The detection method according to clause 10 can correctly identify a peak in a chromatogram as the peak of the target component.

### (Clause 11)

A non-transitory computer readable medium storing a detection program for detecting an anomaly in an identification result of a target component according to an aspect, the detection program causing a computer to perform processing including:
acquiring a plurality of pieces of detection data detected by a chromatograph, the plurality of pieces of detection data corresponding, on a one-to-one basis, to a plurality of samples; and
processing the plurality of pieces of detection data acquired in the acquiring, in which
the processing includes:
   acquiring an identification result indicating that peak information regarding signal intensity extracted from each of the plurality of pieces of detection data is identified as peak information regarding signal intensity corresponding to a target component; and
   detecting, in a case where there is outlier peak information among a plurality of pieces of the peak information identified for respective ones of the plurality of pieces of detection data, that an identification result corresponding to the outlier peak information is anomalous.

The detection program according to clause 11 can correctly identify a peak in a chromatogram as the peak of the target component.

### (Clause 12)

A detection system according to an aspect includes:
a chromatograph; and
a detection device that detects an anomaly in an identification result of a target component, in which
the detection device includes:
   an acquisition unit that acquires a plurality of pieces of detection data detected by a chromatograph, the plurality of pieces of detection data corresponding, on a one-to-one basis, to a plurality of samples; and
   a computing unit that processes the plurality of pieces of detection data acquired by the acquisition unit, and
the computing unit acquires an identification result indicating that peak information regarding signal intensity extracted from each of the plurality of pieces of detection data is identified as peak information regarding signal intensity corresponding to the target component, and detects, in a case where there is outlier peak information among a plurality of pieces of the peak information identified for respective ones of the plurality of pieces of detection data, that an identification result corresponding to the outlier peak information is anomalous.

The detection system according to clause 12 can correctly identify a peak in a chromatogram as the peak of the target component.

Although the embodiments of the present invention have been described, it is clearly understood that the same is by way of illustration and example only and is not to be taken by way of limitation. The scope of the present invention is defined by the claims, and the present invention is intended to include the claims, equivalents of the claims, and all modifications within the scope.

What is claimed is:

1. A detection device comprising:
an acquisition unit that acquires a plurality of pieces of detection data detected by a chromatograph, the plurality of pieces of detection data corresponding, on a one-to-one basis, to a plurality of samples; and
a computing unit that processes the plurality of pieces of detection data acquired by the acquisition unit, wherein
the computing unit acquires an identification result indicating that peak information regarding signal intensity extracted from each of the plurality of pieces of detection data is identified as peak information regarding signal intensity corresponding to a target component, and detects, in a case where there is outlier peak information among a plurality of pieces of the peak information identified for respective ones of the plurality of pieces of detection data, that an identification result corresponding to the outlier peak information is anomalous.

2. The detection device according to claim 1, wherein
the computing unit causes a display device to display the outlier peak information in an emphasized manner as compared to other peak information different from the outlier peak information.

3. The detection device according to claim 1, wherein
the computing unit acquires a measure of central tendency on a basis of other peak information different from the outlier peak information, and
replaces the outlier peak information with the measure of central tendency.

4. The detection device according to claim 3, wherein
the computing unit causes a display device to display, in a recognizable manner, both the peak information before the outlier peak information is replaced with the measure of central tendency and the peak information after the outlier peak information is replaced with the measure of central tendency.

5. The detection device according to claim 1, wherein
the peak information includes a retention time when signal intensity is at a maximum.

6. The detection device according to claim 1, wherein
the peak information includes at least one of a retention time when signal intensity starts to rise, a retention time when signal intensity stops falling, or a position of a baseline.

7. The detection device according to claim 1, wherein
the computing unit corrects in advance a retention time included in each of the plurality of pieces of detection data.

8. The detection device according to claim 1, wherein
the detection device determines whether or not there is the outlier peak information among the plurality of pieces of the peak information using a Hotelling's T-squared method.

9. The detection device according to claim 1, wherein
the plurality of samples include a standard sample used to generate information for identifying the target component from the peak information.

10. A detection method for causing a computer to detect an anomaly in an identification result of a target component, the detection method comprising:
acquiring a plurality of pieces of detection data detected by a chromatograph, the plurality of pieces of detection data corresponding, on a one-to-one basis, to a plurality of samples; and
processing the plurality of pieces of detection data acquired in the acquiring, wherein
the processing includes:
acquiring an identification result indicating that peak information regarding signal intensity extracted from each of the plurality of pieces of detection data is identified as peak information regarding signal intensity corresponding to a target component; and
detecting, in a case where there is outlier peak information among a plurality of pieces of the peak information identified for respective ones of the plurality of pieces of detection data, that an identification result corresponding to the outlier peak information is anomalous.

11. A non-transitory computer readable medium storing a detection program for detecting an anomaly in an identification result of a target component, the detection program causing a computer to perform processing comprising:
acquiring a plurality of pieces of detection data detected by a chromatograph, the plurality of pieces of detection data corresponding, on a one-to-one basis, to a plurality of samples; and
processing the plurality of pieces of detection data acquired in the acquiring, wherein
the processing includes:
acquiring an identification result indicating that peak information regarding signal intensity extracted from each of the plurality of pieces of detection data is identified as peak information regarding signal intensity corresponding to a target component; and
detecting, in a case where there is outlier peak information among a plurality of pieces of the peak information identified for respective ones of the plurality of pieces of detection data, that an identification result corresponding to the outlier peak information is anomalous.

12. A detection system comprising:
a chromatograph; and
a detection device that detects an anomaly in an identification result of a target component, wherein
the detection device includes:
an acquisition unit that acquires a plurality of pieces of detection data detected by a chromatograph, the plurality of pieces of detection data corresponding, on a one-to-one basis, to a plurality of samples; and
a computing unit that processes the plurality of pieces of detection data acquired by the acquisition unit, and
the computing unit acquires an identification result indicating that peak information regarding signal intensity extracted from each of the plurality of pieces of detection data is identified as peak information regarding signal intensity corresponding to the target component, and detects, in a case where there is outlier peak information among a plurality of pieces of the peak information identified for respective ones of the plurality of pieces of detection data, that an identification result corresponding to the outlier peak information is anomalous.
